(19) United States
(12) Patent Application Publication
(10) Pub. No.: US 2025/0300396 A1
(43) Pub. Date: Sep. 25, 2025

(54) Connector Locking Component and Connector

(71) Applicant: Tyco Electronics (Shanghai) Co., Ltd., Shanghai (CN)

(72) Inventors: Hongjian (Neil) Ni, Shanghai (CN); David (Xinjie) Zhang, Shanghai (CN)

(73) Assignee: Tyco Electronics (Shanghai) Co., Ltd., Shanghai (CN)

(21) Appl. No.: 19/089,651

(22) Filed: Mar. 25, 2025

(30) Foreign Application Priority Data
Mar. 25, 2024 (CN) 202410348600.0

(51) Int. Cl. H01R 13/627

(52) U.S. Cl. CPC H01R 13/627

(57) ABSTRACT

A connector locking component includes a fixing part, a crossbeam, a spring arm, and a pair of elastic lock buckles. The fixing part is adapted to fix to a housing of a connector and having front and rear sides opposite in a longitudinal direction. The crossbeam extends along a transverse direction perpendicular to the longitudinal direction and has opposite ends in the transverse direction. The shaped spring arm is connected between the rear side of the crossbeam and the rear side of the fixing part. The pair of elastic lock buckles are located at both ends of the crossbeam. Each lock buckle includes a cantilever a hook formed at the end of the cantilever for engaging with a mating housing of a mating connector, and a retaining part.

### CROSS-REFERENCE TO RELATED APPLICATION

This application claims the benefit of Chinese Patent Application No. CN202410348600.0 filed on Mar. 25, 2024 in the State Intellectual Property Office of China, the whole disclosure of which is incorporated herein by reference.

### FIELD OF THE DISCLOSURE

The disclosure relates to a connector locking component and a connector comprising the connector locking component.

### BACKGROUND OF THE INVENTION

In the prior art, in order to lock a housing of a connector to a mating housing of a mating connector, a locking component is usually installed on the housing of the connector, which typically includes a fixing part, a crossbeam, a U-shaped spring arm, and a pair of elastic locks. The fixing part is fixed to the housing, and the U-shaped spring arm is connected between the fixing part and the crossbeam. The pair of elastic lock buckles are respectively connected to both ends of the crossbeam. the elastic lock buckle is used to connect with the mating housing. The U-shaped spring arm is used to provide a longitudinal engagement force to the elastic lock buckle and to automatically reset the elastic lock buckle from the unlocking position to the locking position. When unlocking the elastic lock buckle, the U-shaped elastic arm can be driven to deform elastically by pulling the unlocking belt connected to the crossbeam.

In order to improve the longitudinal engagement force between the elastic lock buckle and the mating housing of the prior art arrangement, it is necessary to enhance the strength of the U-shaped spring arm. However, enhancing the strength of the U-shaped spring arm results in a higher stiffness of the arm, requiring greater unlocking force and make unlocking the locking component difficult.

### SUMMARY OF THE INVENTION

According to an embodiment of the present disclosure, a connector locking component includes a fixing part, a crossbeam, a spring arm, and a pair of elastic lock buckles. The fixing part is adapted to fix to a housing of a connector and having front and rear sides opposite in a longitudinal direction. The crossbeam extends along a transverse direction perpendicular to the longitudinal direction and has opposite ends in the transverse direction. The shaped spring arm is connected between the rear side of the crossbeam and the rear side of the fixing part. The pair of elastic lock buckles are located at both ends of the crossbeam. Each of the lock buckles includes: a cantilever extending a predetermined length along the longitudinal direction; a hook formed at the end of the cantilever for engaging with a mating housing of a mating connector; and a retaining part formed at the root of the cantilever. When the hook is engaged with the mating housing, the retaining part is pressed against a step portion of the housing along the longitudinal direction to increase the longitudinal engagement force between the hook and the mating housing.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector according to an exemplary embodiment of the present invention;

FIG. 2 shows an illustrative perspective view of a connector locking component and unlocking belt according to an exemplary embodiment of the present invention when viewed from the rear side;

FIG. 3 shows an illustrative perspective view of a connector locking component and unlocking belt according to an exemplary embodiment of the present invention when viewed from the front side;

FIG. 4 shows an illustrative perspective view of a connector locking component according to an exemplary embodiment of the present invention when viewed from the rear side;

FIG. 5 shows an illustrative perspective view of a connector locking component according to an exemplary embodiment of the present invention when viewed from the front side;

FIG. 6 shows a horizontal sectional view of a connector according to an exemplary embodiment of the present invention;

FIG. 7 shows an illustrative exploded view of a connector according to an exemplary embodiment of the present invention;

FIG. 8 shows a vertical sectional view of a connector according to an exemplary embodiment of the present invention;

FIG. 9 shows an illustrative perspective view of a connector according to an exemplary embodiment of the present invention, wherein the back cover is shown; and

FIG. 10 shows an illustrative perspective view of a connector according to an exemplary embodiment of the present invention, where the back cover has not yet been installed onto the housing.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector locking component comprises: a fixing part for fixing to a housing of a connector and having front and rear sides opposite in a longitudinal direction; a crossbeam extending along a transverse direction perpendicular to the longitudinal direction and having opposite ends in the transverse direction; a U-shaped spring arm connected between the rear side of the crossbeam and the rear side of the fixing part; and a pair of elastic lock buckles located at both ends of the crossbeam. The elastic lock buckle comprises: a cantilever extending a predetermined length along the longitudinal direction; a hook formed at the end of the cantilever for engaging with a mating housing of a mating connector; and a retaining part formed at the root of the cantilever. When the hook is engaged with the mating housing, the retaining part is pressed against a step portion of the housing along the longitudinal direction to increase the longitudinal engagement force between the hook and the mating housing.

According to another embodiment of the present disclosure, a connector comprises: a housing formed with a receiving slot and a step portion; and the above connector locking component installed to the housing. The fixing part is fixed to the housing, and the crossbeam and the elastic lock buckle are suspended in a movable manner in the receiving slot of the housing, the hook is exposed from the receiving slot for engagement with a mating housing of a mating connector. When the hook is engaged with the mating housing, the retaining part is pressed against the step portion along the longitudinal direction of the housing to increase the longitudinal engagement force between the hook and the mating housing.

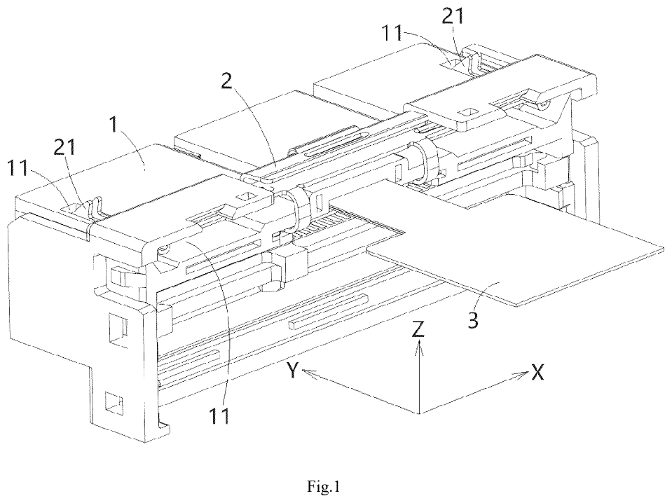

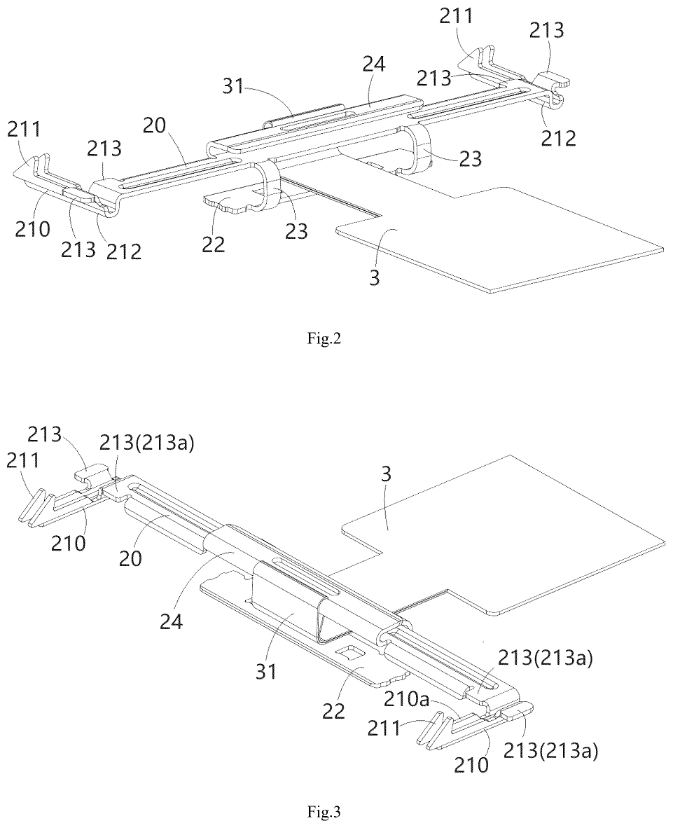

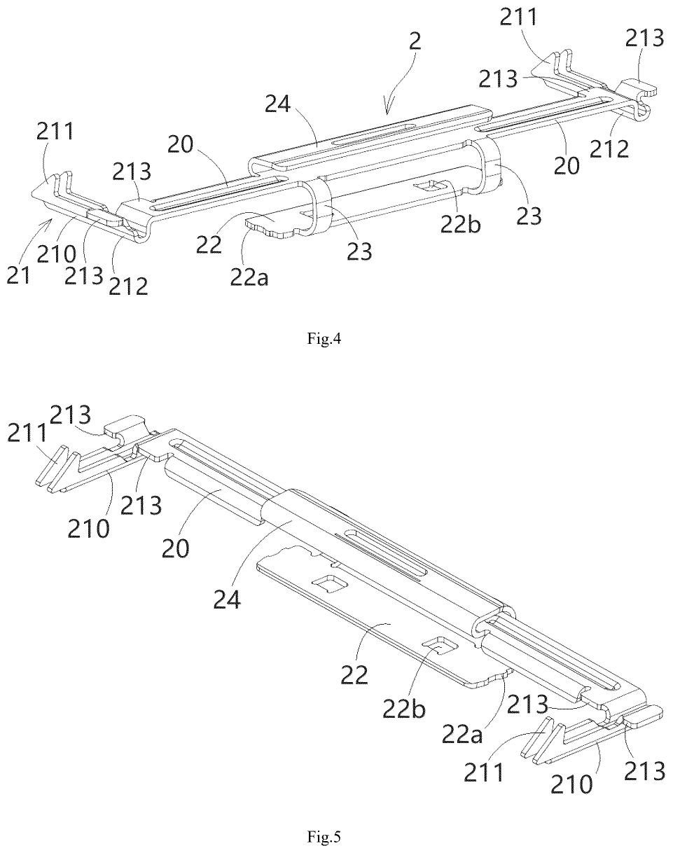

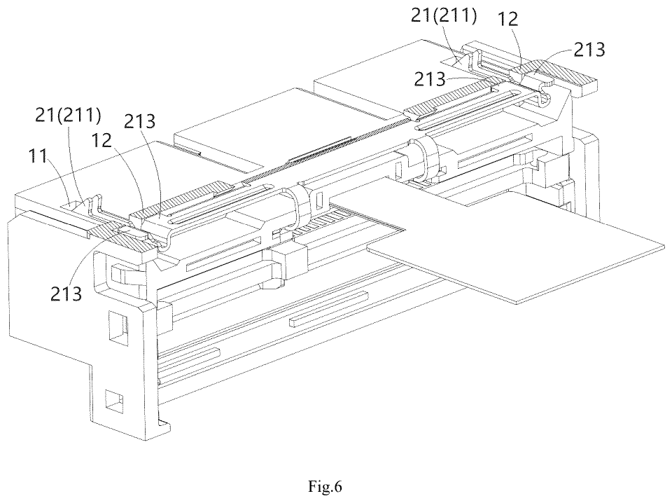

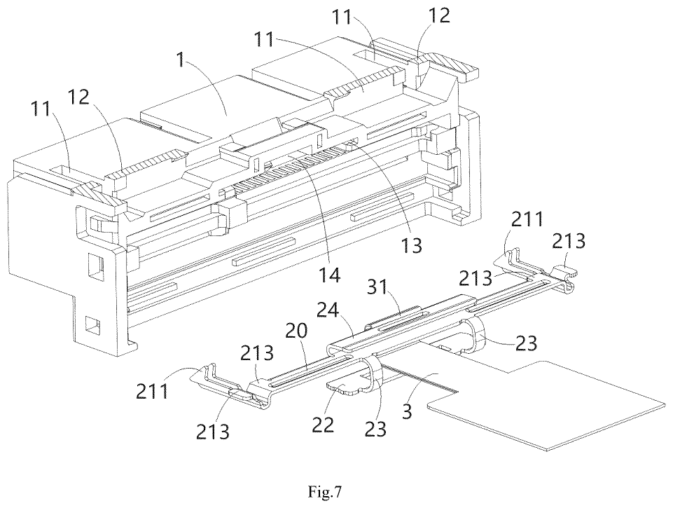

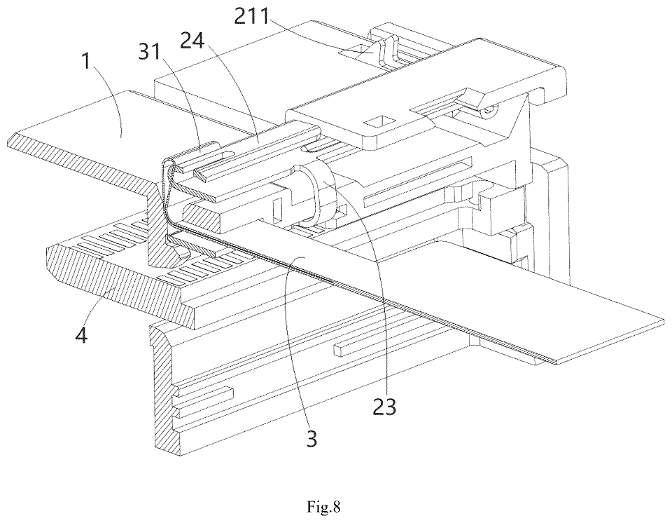

FIG. 1 shows an illustrative perspective view of a connector according to an exemplary embodiment of the present invention. FIG. 2 shows an illustrative perspective view of the connector locking component 2 and unlocking belt 3 when viewed from the rear side according to an exemplary embodiment of the present invention. FIG. 3 shows an illustrative perspective view of the connector locking component 2 and unlocking belt 3 when viewed from the front side according to an exemplary embodiment of the present invention. FIG. 4 shows an illustrative perspective view of the connector locking component 2 according to an exemplary embodiment of the present invention when viewed from the rear side. FIG. 5 shows a perspective view of the connector locking component 2 according to an exemplary embodiment of the present invention when viewed from the front side. FIG. 6 shows a horizontal sectional view of a connector according to an exemplary embodiment of the present invention. FIG. 7 shows an illustrative exploded view of a connector according to an exemplary embodiment of the present invention. FIG. 8 shows a vertical sectional view of a connector according to an exemplary embodiment of the present invention.

As shown in FIGS. 1-8, in an exemplary embodiment of the present disclosure, a connector locking component 2 is provided. The locking component 2 of the connector includes: a fixing part 22, a crossbeam 20, a U-shaped spring arm 23 and a pair of elastic lock buckles 21. The fixing part 22 is used to fix to the housing 1 of the connector and has front and rear sides that are opposite in the longitudinal direction Y. The crossbeam 20 extends along the transverse direction X perpendicular to the longitudinal direction Y and has two opposite ends in the transverse direction X. The U-shaped spring arm 23 is connected between the rear side of the crossbeam 20 and the rear side of the fixing part 22. The pair of elastic lock buckles 21 are respectively located at both ends of the crossbeam 20. The elastic lock buckle 21 includes a cantilever arm 210, a hook 211, and a retaining part 213. The cantilever 210 extends a predetermined length along the longitudinal direction Y. The hook 211 is formed on the end of the cantilever 210 for engagement with a mating housing (not shown) of a mating connector (not shown). The retaining part 213 is formed at the root 212 of the cantilever 210. When the hook 211 is engaged with the mating housing, the retaining part 213 is pressed against the step portion 12 of the housing 1 along the longitudinal direction Y to increase the longitudinal engagement force between the hook 211 and the mating housing.

The connector locking component 2 further includes a connection part 24, which is connected to the front side of the crossbeam 20. The connection part 24 is used to connect with a unlocking belt 3, and the U-shaped spring arm 23 can deform from an initial state to a predetermined deformation state under the pulling of the unlocking belt 3. When the U-shaped spring arm 23 undergoes elastic deformation from the initial state to the predetermined deformation state, the hook 211 is moved downward from a locking position engaged with the mating housing to a unlocking position separated from the mating housing.

The fixing part 22, the U-shaped spring arm 23, and the connection part 24 are located at the middle portion between the two ends of the crossbeam 20. The connection part 24 extends forward from the front side of the crossbeam 20 and is bent upward and backward, making the connection part 24 U-shaped. A slot hole is formed in the connection part 24 to allow one end 31 of the unlocking belt 3 to pass through, allowing one end 31 of the unlocking belt 3 to be connected to the connection part 24. The crossbeam 20 and the fixing part 22 are spaced opposite each other in a height direction Z perpendicular to the transverse direction X and the longitudinal direction Y. The crossbeam 20 and the elastic lock buckle 21 are suspended above the fixing part 22, and can be moved upward and downward relative to the fixing part 22. The connector locking component 2 further includes a pair of U-shaped spring arms 23, which are spaced apart in the transverse direction X to allow the unlocking belt 3 to pass through between the pair of U-shaped spring arms 23.

The fixing part 22 is in the shape of a plate extending along the transverse direction X and longitudinal direction Y and is suitable for being inserted and fixed into the slot 13 in the housing 1. The fixing part 22 has left and right sides 22a that are opposite in the transverse direction X. The left and right sides 22a of the fixing part 22 are suitable for interference fit with the inner wall of the slot 13 of the housing 1 to fix the fixing part 22 to the housing 1. A slot hole 22b is formed in the fixing part 22, and the slot hole 22b is used to engage with the protrusion inside the slot 13 to fix the fixing part 22 to the housing 1.

The retaining part 213 includes two side wings 213a respectively connected to the left and right sides of the root 212 of the cantilever 210. The front side of the side wing 213a is suitable to rest against the rear side of the step portion 12 of the housing 1 along the longitudinal direction Y, in order to increase the longitudinal engagement force between the hook 211 and the mating housing. The crossbeam 20 is connected between the side wings 213a of the pair of elastic lock buckles 21. In the illustrated embodiment, the cross-section of the cantilever 210 is U-shaped and includes a pair of side plates 210a opposite each other in the transverse direction X. The hook 211 is formed at the end of each of the pair of side plates 210a, and two side wings 213a are respectively connected to the roots of the pair of side plates 210a.

The connector locking component is an integral stamped part. This can reduce manufacturing costs.

Still referring to FIGS. 1 to 8, in another exemplary embodiment of the present invention, a connector is also disclosed. The connector includes a housing 1 and the aforementioned connector locking component 2. A receiving slot 11 and a step portion 12 are formed in the housing 1. The connector locking component 2 is installed onto the housing 1. The fixing part 22 of the connector locking component 2 is fixed to the housing 1. The crossbeam 20 and elastic lock buckle 21 of the connector locking component 2 are suspended in the receiving slot 11 of the housing 1 in a movable manner, and the hook 211 is exposed from the receiving slot 11 for engagement with the mating housing of the mating connector. When the hook 211 is engaged with the mating housing, the retaining part 213 is pressed against the step portion 12 along the longitudinal direction Y of the housing 1 to increase the longitudinal engagement force between the hook 211 and the mating housing.

In the illustrated embodiment, a slot 13 is formed in the housing 1, and the fixing part 22 is inserted into the slot 13 in the housing 1 in an interference fit manner to fix the fixing part 22 to the housing 1. A protrusion is formed in the slot 13 of the housing 1, and the protrusion engages with the slot hole 22b in the fixing part 22 to fix the fixing part 22 to the housing 1.

The connector further comprises an unlocking belt 3, which is connected to the connection part 24 of the connector locking component 2 and extends from the rear side of the housing 1. The elastic lock buckle 21 can be moved from the locking position engaged with the mating housing to the unlocking position separated from the mating housing under the pulling of the unlocking belt 3. A horizontal slot 14 is formed in the rear side of the housing 1, which extends along the transverse direction X and the longitudinal direction Y of the housing 1 and allows the unlocking belt 3 to pass through. One end 31 of the unlocking belt 3 is bent upward relative to the horizontal slot 14 and connected to the connection part 24 of the connector locking component 2.

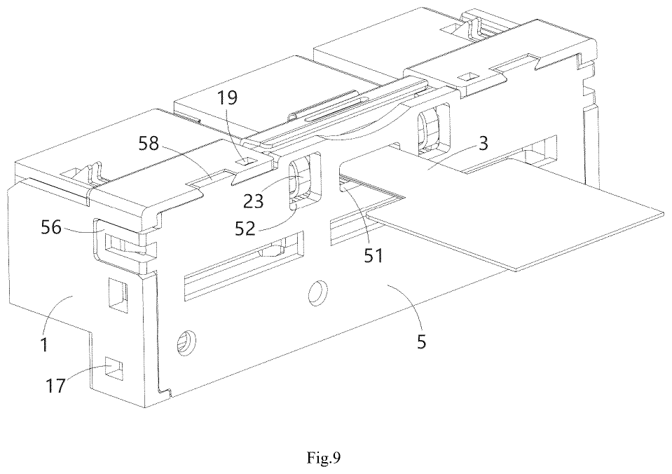

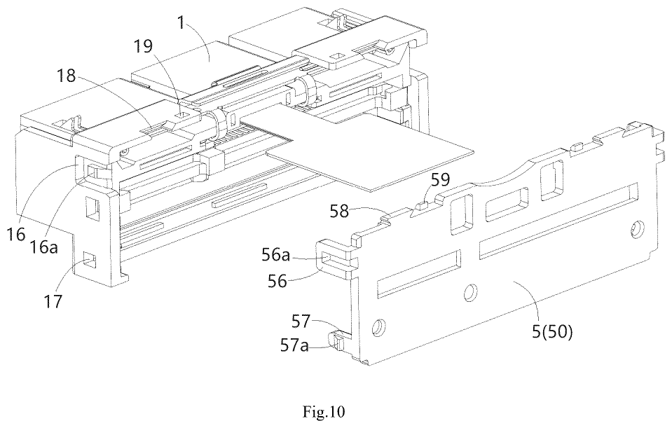

FIG. 9 shows an illustrative perspective view of a connector according to an exemplary embodiment of the present invention, wherein the back cover 5 is shown. FIG. 10 shows an illustrative perspective view of a connector according to an exemplary embodiment of the present invention, where the back cover 5 has not yet been installed on the housing 1.

As shown in FIGS. 1-10, in the illustrated embodiment, the connector further comprises a back cover 5 mounted on the rear side of the housing 1. A through hole 51 that allows the unlocking belt 3 to pass through and a receiving hole 52 for accommodating the U-shaped spring arm 23 are formed in the back cover 5. The back cover 5 includes a cover plate 50 and multiple first elastic buckles 56 connected to the left and right sides of the cover plate 50, respectively. A first slot 56a is formed in the first elastic buckle 56. A first recess 16 and a first protrusion 16a located inside the first recess 16 are respectively formed on the outer side of each of the left and right side walls of the housing 1. The first elastic buckle 56 is positioned in the first recess 16, and the first protrusion 16a is engaged with the first slot 56a.

The back cover 5 further includes second elastic buckles 57 respectively connected to the left and right sides of the cover plate 50, and a second protrusion 57a is formed on the second elastic buckle 57. There are second slots 17 respectively formed in the left and right side walls of housing 1. The second elastic buckle 57 is located on the inner side of housing 1. The second protrusion 57a is engaged into the second slot 17.

A positioning protrusion 58 and an engagement protrusion 59 are formed on the upper side of the back cover 5. A positioning slot 18 and an engagement hole 19 are formed in the top wall of the receiving slot 11 of the housing 1. The positioning protrusion 58 and the positioning slot 18 are in a dovetail shape and are engaged with each other, and the engagement protrusion 59 is engaged into the engagement hole 19.

In the illustrated embodiment, the connector further comprises a circuit board 4. The circuit board 4 is installed into the housing 1 for electrical contact with terminals (not shown) inside the mating connector.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector locking component, comprising:
a fixing part adapted to be fixed to a housing of a connector and having front and rear sides opposite in a longitudinal direction;
a crossbeam extending along a transverse direction perpendicular to the longitudinal direction and having opposite ends in the transverse direction;
a spring arm connected between a rear side of the crossbeam and the rear side of the fixing part; and
a pair of elastic lock buckles located at both ends of the crossbeam, the elastic lock buckles including:
a cantilever extending a predetermined length along the longitudinal direction;
a hook formed at the end of the cantilever for engaging with a mating housing of a mating connector; and
a retaining part formed at a root of the cantilever, wherein when the hook is engaged with the mating housing, the retaining part is pressed against a step portion of the housing along the longitudinal direction to increase the longitudinal engagement force between the hook and the mating housing.

2. The connector locking component according to claim 1, further comprising a connection part connected to a front side of the crossbeam, wherein:
the connection part is adapted to connect with an unlocking belt, and the spring arm is deformable from an initial state to a predetermined deformation state under the pulling of the unlocking belt; and
when the spring arm is U-shaped and is elastically deformed from the initial state to the predetermined deformation state, the hook is moved downward from a locking position engaged with the mating housing to an unlocking position separated from the mating housing.

3. The connector locking component according to claim 2, wherein:
the fixing part, the U-shaped spring arm, and the connection part are located at a middle location between the two ends of the crossbeam; and
the connection part extends forward from the front side of the crossbeam and is bent upward and backward to be formed in a U-shape.

4. The connector locking component according to claim 3, wherein a slot hole is formed in the connection part to allow one end of the unlocking belt to pass through, and allowing the one end of the unlocking belt to be connected to the connection part.

5. The connector locking component according to claim 2, wherein:
the crossbeam and the fixing part are spaced opposite each other in a height direction perpendicular to the transverse direction and the longitudinal direction; and
the crossbeam and the elastic lock buckle are suspended above the fixing part and are movable upward and downward relative to the fixing part.

6. The connector locking component according to claim 2, wherein the connector locking component includes a pair of U-shaped spring arms spaced apart in the transverse direction allowing the unlocking belt to pass through between the pair of U-shaped spring arms.

7. The connector locking component according to claim 1, wherein:
the fixing part is in the shape of a plate extending along the transverse direction and the longitudinal direction and is adapted to be inserted and fixed into a slot in the housing; and
the fixing part has left and right sides opposite each other in the transverse direction, and the left and right sides of the fixing part are adapted to form an interference fit with the inner wall of the slot of the housing to fix the fixing part to the housing.

8. The connector locking component according to claim 7, wherein a slot hole is formed in the fixing part, the slot hole is adapted to engage with a protrusion inside the slot to fix the fixing part to the housing.

9. The connector locking component according to claim 1, wherein:
the retaining part includes two side wings respectively connected to left and right sides of the root of the cantilever;
the front side of the side wing is adapted to rest against a rear side of the step portion of the housing along the longitudinal direction, in order to increase the longitudinal engagement force between the hook and the mating housing; and
the crossbeam is connected between the side wings of the pair of elastic lock buckles.

10. The connector locking component according to claim 9, wherein the cross-section of the cantilever is U-shaped and includes a pair of side plates opposite each other in the transverse direction, the hook is formed at the end of each of the pair of side plates, and the two side wings are respectively connected to roots of the pair of side plates.

11. The connector locking component according to claim 1, wherein the connector locking component is an integral stamped part.

12. A connector, comprising:
a housing formed with a receiving slot and a step portion; and
the connector locking component according to claim 1, installed to the housing, wherein:
the fixing part is fixed to the housing, and the crossbeam and the elastic lock buckle are suspended in a movable manner in the receiving slot of the housing, the hook is exposed from the receiving slot for engagement with a mating housing of a mating connector; and
when the hook is engaged with the mating housing, the retaining part is pressed against the step portion along the longitudinal direction of the housing to increase the longitudinal engagement force between the hook and the mating housing.

13. The connector according to claim 12, wherein:
a slot is formed in the housing, and the fixing part is inserted into the slot in the housing in an interference fit manner to fix the fixing part to the housing; and
a protrusion is formed in the slot of the housing, and the protrusion engages with the slot hole in the fixing part to fix the fixing part to the housing.

14. The connector according to claim 12, further comprising an unlocking belt connected to the connection part of the connector locking component and extends from the rear side of the housing, wherein the elastic lock buckle is movable the locking position engaged with the mating housing to the unlocking position separated from the mating housing under the pulling of the unlocking belt.

15. The connector according to claim 14, wherein:
a horizontal slot is formed in the rear side of the housing and extends along the transverse direction and the longitudinal direction of the housing and allows the unlocking belt to pass through; and
one end of the unlocking belt is bent upward relative to the horizontal slot and connected to the connection part of the connector locking component.

16. The connector according to claim 14, further comprising a back cover installed on the rear side of the housing, wherein a through-hole allowing the unlocking belt to pass through and a receiving hole accommodating the spring arm are formed in the back cover.

17. The connector according to claim 16, wherein:
the back cover includes a cover plate and multiple first elastic buckles respectively connected to the left and right sides of the cover plate, a first slot is formed in the first elastic buckle; and
a first recess and a first protrusion located inside the first recess are formed on the outer side of each of the left and right side walls of the housing, the first elastic buckle is positioned in the first recess, and the first protrusion is engaged with the first slot.

18. The connector according to claim 17, wherein:
the back cover further includes a second elastic buckle respectively connected to the left and right sides of the cover plate, and a second protrusion is formed on the second elastic buckle; and
second slots are respectively formed on the left and right side walls of the housing, and the second elastic buckle is located on the inner side of the housing, the second protrusion is engaged into the second slot.

19. The connector according to claim 17, wherein:
a positioning protrusion and an engagement protrusion are formed on the upper side of the back cover, and a positioning slot and an engagement hole are formed on the top wall of the receiving slot of the housing; and
the positioning protrusion and the positioning slot are in a dovetail shape and are engaged with each other, and the engagement protrusion is engaged into the engagement hole.

20. The connector according to claim 12, further comprising a circuit board installed into the housing for electrical contact with terminals inside the mating connector.
